(19) United States
(12) Patent Application Publication
(10) Pub. No.: US 2026/0339940 A1
(43) Pub. Date: Oct. 29, 2026

(54) METHOD AND SYSTEM FOR OPTIMIZING PROMPTS FOR LARGE LANGUAGE MODELS (LLMS)

(71) Applicant: LTI Mindtree Ltd., Mumbai (IN)

(72) Inventors: Sahithi Priya Vadlakonda, Mumbai (IN); T Siva Rama Sarma, Mumbai (IN); Sateesh Gottumukkala, Mumbai (IN); Ashish Varerkar, Mumbai (IN)

(21) Appl. No.: 19/454,560

(22) Filed: Jan. 21, 2026

(30) Foreign Application Priority Data
Apr. 23, 2025 (IN) 202521039268

(51) Int. Cl. G06F 16/2452

(52) U.S. Cl. CPC G06F 16/24522

(57) ABSTRACT

A method and system for optimizing prompts for LLMs is disclosed. The system receives a baseline prompt configured for interacting with an LLM, and transforms it into a structured prompt in accordance with a standardized architecture by utilizing prompt engineering templates. An iterative prompt optimization process is performed that comprises evaluating performance of the structured prompt against a ground truth dataset comprising query-response pairs. A plurality of prompt variations for the structured prompt are generated based on a performance metrics obtained from the evaluation. The system refines structured prompt by incorporating elements from the one or more optimal prompt variations. The refined structured prompt is stored in a centralized prompt management system that maintains version control for a plurality of prompts, and a user interface is provided that enables users to interact with the LLM using the refined structured prompt.

### FIELD

Various embodiments of the present disclosure generally relate to prompt optimization. More particularly, the disclosure relates to a method and system for optimizing and delivering efficient, contextually relevant prompts for large language models (LLMs) with an iterative prompt optimization algorithm.

### BACKGROUND

In recent years, the field of prompt engineering for LLMs has witnessed a significant increase in both complexity and demand. As LLMs continue to evolve with enhanced capabilities, effectively communicating tasks and expectations through natural language prompts has become increasingly nuanced. Users are no longer limited to simple queries, instead, they often seek detailed, context-aware responses that require careful construction of prompts to achieve optimal results.

Traditional methods of prompt creation, which typically relied on ad-hoc or manually crafted instructions, often led to suboptimal performance when interacting with the LLMs. These rudimentary approaches lacked a systematic structure, making them prone to a range of issues. One common problem was hallucination, where the model generated information that was factually incorrect or entirely fabricated. Additionally, prompts frequently suffered from contextual irrelevance, resulting in responses that failed to align with the intended meaning or objective of the query. Information bias was another persistent challenge, where the model's output was skewed due to ambiguities or unintended implications embedded in the prompt.

Existing solutions in the domain of prompt engineering have primarily relied on manual techniques, which are inherently time-consuming, labor-intensive, and difficult to scale across diverse applications. While recent advancements have introduced various optimization frameworks and algorithmic approaches aimed at enhancing prompt performance, many of these methods still fall short in key areas. Notably, they often lack a structured, task-oriented approach to prompt formulation, one that clearly delineates the intended goal, input expectations, output constraints, and logical reasoning pathways. Furthermore, these frameworks typically do not incorporate guided thinking strategies, such as step-by-step reasoning or modular decision-making, which are essential for generating accurate and contextually appropriate responses.

The evaluation methodologies used to assess prompt effectiveness also tend to be fragmented or inefficient, making it challenging to iteratively improve prompt quality in a systematic manner. Compounding these limitations is the absence of a centralized infrastructure for prompt management, version control, and optimization. This lack of an integrated system leads to inconsistency in prompt performance, redundant efforts across teams, and elevated operational costs associated with managing prompt libraries in dynamic environments.

Some existing approaches attempt to optimize instructions for black-box LLMs by leveraging soft prompts applied to open-source LLMs. In these methods, a soft prompt-a trainable, continuous prompt representation, is used to guide an open-source language model in generating human-readable, task-relevant instructions. These instructions are subsequently provided to the target black-box LLM, which produces zero-shot predictions in response to downstream tasks. The quality of these predictions is quantified using a performance score, which is then employed to iteratively update the soft prompt parameters through techniques such as Bayesian optimization. The process is cyclical: as performance feedback is gathered, the soft prompt is refined to guide the open-source model toward generating increasingly effective instructions. While this strategy offers a novel workaround for the black-box nature of commercial LLMs, it suffers from key limitations. Important among them is the challenge of combinatorial optimization, where the search space for effective instructions is vast and difficult to explore efficiently. Additionally, the approach remains constrained by the lack of transparency and limited adaptability of black-box models, which hinders the ability to perform fine-grained tuning or interpret the causal relationships between prompt modifications and model behavior.

Further, certain existing solutions have explored the use of evolutionary algorithms for optimizing task-specific prompts. These methods typically begin with an initial task-prompt and iteratively generate new prompt variants through a mutation operator. Notably, the mutation operator in such systems is often instantiated as a language model itself, conditioned on a predefined mutation-prompt to produce altered task-prompts. Each mutated task-prompt is subsequently evaluated for fitness based on its performance over a batch of question-and-answer (Q&A) pairs drawn from a training dataset. A distinctive feature of this approach lies in its self-referential architecture: the evolutionary process is applied not only to the task-prompts but also to the mutation-prompts themselves.

This meta-level optimization is facilitated by a hyper-mutation prompt, which guides the generation of new mutation-prompts, thereby allowing the system to evolve both prompt content and mutation strategies in parallel. The population of mutated task-prompts is typically managed and evolved using a binary tournament selection mechanism within a genetic algorithm framework. While this methodology introduces a novel multi-level prompt optimization paradigm, it is computationally intensive and heavily reliant on stochastic evolutionary strategies. As a result, it may struggle to converge efficiently or consistently produce optimal prompt configurations, especially when dealing with large-scale or highly variable tasks.

Moreover, some existing approaches adopt an iterative, feedback-driven methodology for prompt optimization. These systems typically begin with an initial prompt instruction accompanied by a set of training samples, using an LLM to generate outputs for evaluation. The core objective is to iteratively refine both the prompt and the selection of few-shot examples to enhance task accuracy over successive iterations. Such frameworks are generally structured around four primary components: a Mutate Component, which generates prompt variations using cognitive heuristics or pre-defined transformation rules; a Scoring Component, which assesses the performance of each variation based on predefined evaluation metrics; a Critique Component, which provides qualitative feedback on high-performing prompts by identifying strengths and weaknesses; and a Synthesize Component, which incorporates the critique to produce refined prompt versions.

While this approach presents a structured workflow for prompt refinement, its effectiveness is often constrained by the capabilities of its individual components. Specifically, the quality and diversity of mutations, the reliability of scoring functions, the interpretability of critiques, and the synthesis logic may collectively limit the system's ability to generalize across tasks or scale efficiently. Furthermore, these solutions typically operate in isolated research environments and lack a centralized dashboard or infrastructure for holistic prompt lifecycle management. This absence of integrated version control, collaboration tools, and deployment readiness significantly hinders adoption in production-grade or enterprise-level applications.

Moreover, through this iterative, feedback-driven process, the aforementioned existing solution primarily operates within research-oriented settings, emphasizing task-specific performance metrics. While such evaluation methods may yield improvements in isolated tasks, they often lack the robustness, scalability, and generalizability required for real-world deployment. Specifically, these approaches do not incorporate comprehensive evaluation frameworks capable of assessing prompts across diverse domains, user intents, and usage contexts. Additionally, they are deficient in mechanisms for continuous improvement, such as automated benchmarking, longitudinal performance tracking, and adaptive learning from evolving user interactions. This narrow focus on static, task-level optimization significantly limits the broader applicability and operational maturity of such systems.

Therefore, there is a need for a method and system that addresses the one or more aforementioned challenges with a technically effective solution comprising a centralized dashboard for automating prompt optimization, delivering contextually relevant prompts, version control, cost monitoring, and KPI tracking.

### SUMMARY

A method and system for optimizing prompts for LLMs is disclosed. The system receives a baseline prompt configured for interacting with a LLM, and transforms the baseline prompt into a structured prompt in accordance with a standardized architecture comprising at least one of a prompt goal, task, expected inputs from user, output fields, formats, personas, output constraints, and methodology thinking steps defining a sequential process for deriving outputs. Transforming the baseline prompt into a structured prompt comprises utilizing one or more prompt engineering templates selected from a group consisting of: few-shot templates, chain of thought templates, tree of thought templates, and custom templates.

The system performs an iterative prompt optimization process that comprises evaluating performance of the structured prompt against a ground truth (reference dataset) dataset comprising a plurality of query-response pairs. Thereafter, the system generates a plurality of prompt variations for the structured prompt based on a performance metrics obtained from the evaluation. One or more optimal prompt variations are selected using computational optimization algorithms that maximize the performance metrics. The system refines structured prompt by incorporating elements from the one or more optimal prompt variations.

The refined structured prompt is stored in a centralized prompt management system that maintains version control for a plurality of prompts, and the system provides a user interface that enables users to interact with the LLM using the refined structured prompt. The user interface utilizes the refined structured prompt to generate response to user queries.

### BRIEF DESCRIPTION OF THE FIGURES

FIG. 1 is a diagram that illustrates an exemplary embodiment within which various embodiments of the present disclosure may function.

FIG. 2 is a diagram that illustrates a system for optimizing prompts for LLMs, in accordance with an embodiment of the disclosure.

FIG. 3 is an exemplary diagram that illustrates interaction of a user with an LLM via the system 102, in accordance with an embodiment of the disclosure.

FIG. 4 is a diagram that illustrates a flowchart for a method for optimizing prompts for LLMs, in accordance with an embodiment of the disclosure.

FIG. 5 is a diagram that illustrates a workflow for creating prompt sequence pipeline, in accordance with an embodiment of the disclosure.

### DETAILED DESCRIPTION

Pursuant to various embodiments, the present disclosure provides a method and system for optimizing prompts for LLMs. The system receives a baseline prompt configured for interacting with a LLM, and transforms the baseline prompt into a structured prompt in accordance with a standardized architecture comprising at least one of a prompt goal, task, expected inputs from user, output fields, formats, personas, output constraints, and methodology thinking steps defining a sequential process for deriving outputs. Transforming the baseline prompt into a structured prompt comprises utilizing one or more prompt engineering templates selected from a group consisting of few-shot templates, chain of thought templates, tree of thought templates, and custom templates.

The system performs an iterative prompt optimization process that comprises evaluating performance of the structured prompt against a ground truth (reference dataset) dataset comprising a plurality of query-response pairs. Thereafter, the system generates a plurality of prompt variations for the structured prompt based on a performance metrics obtained from the evaluation. One or more optimal prompt variations are selected using computational optimization algorithms that maximize the performance metrics. The system refines structured prompt by incorporating elements from the one or more optimal prompt variations.

The refined structured prompt is stored in a centralized prompt management system that maintains version control for a plurality of prompts, and the system provides a user interface that enables users to interact with the LLM using the refined structured prompt. The user interface utilizes the refined structured prompt to generate response to user queries.

In one or more embodiments, prompts refer to structured natural language instructions or input formulations designed to guide an LLM in generating contextually appropriate and task-specific responses. Prompts may include various components such as task descriptions, user intents, input constraints, output formatting guidelines, role-based personas, and sequential reasoning steps, all of which collectively influence the behavior and output quality of the LLM.

In one or more embodiments, prompt optimization refers to the systematic process of refining, structuring, and enhancing input prompts to improve the quality, relevance, and accuracy of outputs generated by an LLM. This process may involve transforming an initial or baseline prompt into a structured format using predefined templates, evaluating prompt effectiveness against reference datasets or performance metrics, generating variations through computational methods, and selecting optimal prompts based on objective criteria. Prompt optimization may also encompass iterative refinement cycles, guided reasoning strategies, and the incorporation of user feedback or system-generated critiques to continuously improve LLM interaction outcomes.

In one or more embodiments, the baseline prompt refers to an initial natural language input or instruction configured for interaction with an LLM, prior to undergoing any structural transformation or optimization. The baseline prompt may be user-generated or system-provided and typically captures the core intent or task to be performed by the LLM. However, it may lack clarity, structure, contextual grounding, or optimization elements necessary for achieving high-quality and consistent outputs, thereby serving as the starting point for subsequent prompt refinement and enhancement processes.

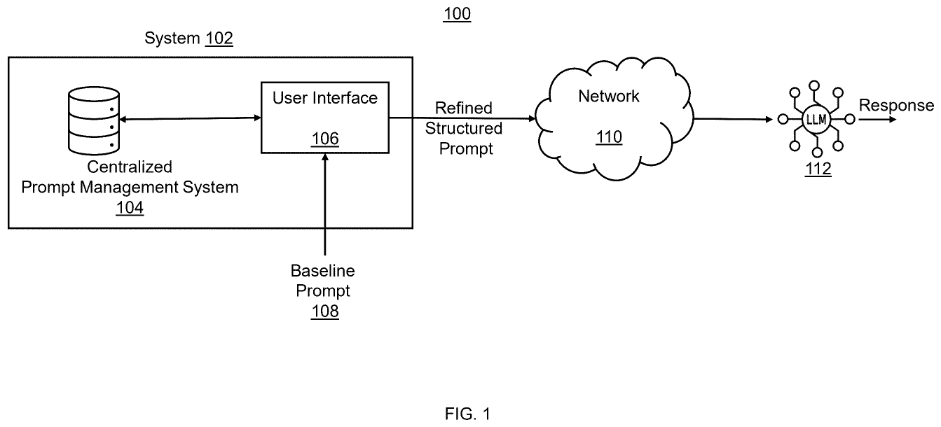

FIG. 1 is a diagram that illustrates an exemplary environment 100 within which various embodiments of the present disclosure may function. Referring to FIG. 1, the environment 100 comprises a system 102 comprising a centralized prompt management (CPM) system 104, a user interface 106, a baseline prompt 108, a network 110, and an LLM 112.

The system 102 is configured to optimize the prompts for the LLMs by organizing and managing prompts based on integral operational components such as, experimentation, engineering, optimization, and evaluation. This modular approach ensures that prompts are not only effective in generating high-quality outputs but are also optimized for efficiency and consistency. To facilitate this, the system 102 utilizes one or more custom-built algorithms, including an iterative prompt optimization algorithm, which systematically refines prompt structures. The optimization algorithm operates in a looped feedback mechanism, wherein it extracts representative examples from a training dataset and iteratively updates the prompt's reasoning logic or “thinking steps” based on performance evaluation metrics. This continuous refinement process enables the generation of structured prompts that are context-aware, task-specific, and aligned with defined performance objectives.

In one or more embodiments, the system 102 comprises functional constructs such as, Prompt Lines, Prompt Sequences, and Interactive Personas, each designed to enhance the efficiency, adaptability, and contextual relevance of prompt generation and optimization. Prompt Lines are configured to automate the extraction and abstraction of salient information from large and complex document corpora, thereby significantly minimizing the need for manual input and accelerating the prompt creation process. Prompt Sequences are utilized to deconstruct complex prompts into modular sub-prompts based on task specificity and operational logic, enabling the system to sequence these sub-prompts through automated engineering and optimization pipelines. Interactive Personas allow prompts to be dynamically aligned with user roles, intent, or domain-specific requirements, thereby improving personalization and output relevance. The system 102 further integrates a variety of prompt engineering techniques and reusable templates to support cost-efficient execution, enhanced operational throughput, and scalable customization. A centralized dashboard provides end-to-end management capabilities, including prompt structuring, template application, version control, and real-time KPI reporting for continuous performance monitoring and refinement.

In some non-limiting embodiments, the system 102 is configured to assist developers in designing and deploying scalable, efficient, and context-aware prompt structuring solutions. By leveraging a combination of effective computational algorithms, advanced prompt engineering strategies, and robust evaluation methodologies, the system 102 aims to significantly enhance the performance, reliability, and adaptability of prompt-based LLM interactions.

The CPM system 104 of the system 102 refers to a dedicated infrastructure component configured to serve as the central repository and control hub for all prompt-related operations within the system 102. It is responsible for aggregating and managing various prompt configurations, including baseline prompts, structured prompts, and refined versions generated through iterative optimization.

In one or more embodiments, the CPM system 104 is configured to store a wide range of refined structured prompts that result from optimization workflows. The refined structured prompts are indexed and cataloged within the CPM system 104 using metadata that reflects their purpose, context, version history, and performance characteristics. To ensure traceability and backward compatibility, the CPM system 104 maintains version control mechanisms that allow for the tracking of changes across multiple iterations of a given prompt. Each version may include annotations or audit logs documenting updates, associated evaluation metrics, and optimization decisions, thereby enabling developers and system operators to roll back or compare different prompt versions as needed.

In one or more embodiments, the CPM system 104 comprises an interactive dashboard interface designed to enable users interaction. This dashboard facilitates prompt structuring by enabling users to define and organize prompt components such as goals, tasks, input-output formats, and thinking methodologies. It also supports templatizing through reusable prompt engineering templates that align with best practices such as few-shot, chain-of-thought, or tree-of-thought paradigms. The versioning module within the dashboard enables seamless navigation through historical prompt iterations, while integrated key performance indicator (KPI) reporting provides real-time visibility into prompt effectiveness based on metrics such as accuracy, latency, cost, and user engagement.

The user interface 106 of the system 104 is configured to serve as the primary access point through which users engage with an LLM using a refined structured prompt. The interface abstracts the complexity of prompt engineering from end users and presents a streamlined interaction layer that leverages the optimized prompt configuration. By utilizing structured and task-specific prompts that have undergone iterative refinement, the user interface 106 ensures that user inputs are contextualized and processed accurately by the LLM. The user interface 106 may be embodied in a variety of forms, including graphical dashboards, web-based interfaces, APIs, or embedded components within third-party platforms, depending on deployment requirements.

In one or more embodiments, the user interface 106 is configured to receive baseline prompts from a user. For example, the user may be a developer, data analyst, domain expert, or any stakeholder intending to generate responses from the LLM 112 through prompt-based interaction. The user interface 106 facilitates the entry of baseline prompts in free-form natural language or semi-structured formats, which are then processed by the system 102 for transformation into structured prompts. In certain implementations, the user interface 106 may include interactive fields, dropdowns, and configurable input modules to guide the user through prompt creation, as well as validation tools to ensure syntactic and semantic completeness.

In one or more embodiments, the user interface 106 is further configured to employ the refined structured prompt as a foundational input for interacting with the LLM 112 to generate responses to user-submitted queries. The refined prompt, which encapsulates clearly defined goals, expected input types, desired output formats, and methodological guidance, is dynamically coupled with user queries to create a highly contextualized LLM request. This structured interaction significantly enhances the LLM's interpretative accuracy and output quality. The user interface 106 may include adaptive features such as prompt previewing, query reformulation suggestions, response validation tools, and interaction history, thereby supporting continuous user engagement and feedback integration into the broader prompt optimization workflow.

The baseline prompt 108 refers to an initial natural language input configured for interaction with the LLM 112, prior to undergoing any structural transformation or optimization. The baseline prompt may be user-generated or system-provided and typically captures the core intent or task to be performed by the LLM.

In one or more embodiments, the user interface 106 is configured to receive a baseline prompt from the user and enable communication between the user and the LLM 112 through structured prompt transformation. Upon receiving the baseline prompt, expressed in natural language or semi-structured form, the system 102 processes the input to generate a structured prompt suitable for effective interaction with the LLM 112. The resulting structured prompt is then passed on to the LLM 112 via the user interface 106.

The network 110 facilitates communication between the various components of the environment 100, including the system 102, and the LLM 112. It enables the transfer of data, instructions, and results between the different modules and the system 102, allowing for seamless optimization of prompts for the LLMs. The network 110 may comprise various communication protocols, such as local area networks (LAN), wide area networks (WAN), or the internet.

The LLM 112, as illustrated in the environment 100, refers to any large language model capable of processing natural language prompts and generating corresponding outputs based on learned knowledge representations. In one or more embodiments, the LLM 112 is not limited to any specific proprietary or open-source model, and may include, but is not restricted to, transformer-based architectures such as GPT, BERT, T5, PaLM, or their fine-tuned or domain-specific variants. The system 102 is agnostic to the underlying LLM implementation and is designed to support interoperability with a wide range of LLM providers and deployments, including cloud-hosted services, on-premise models, and lightweight edge-based configurations.

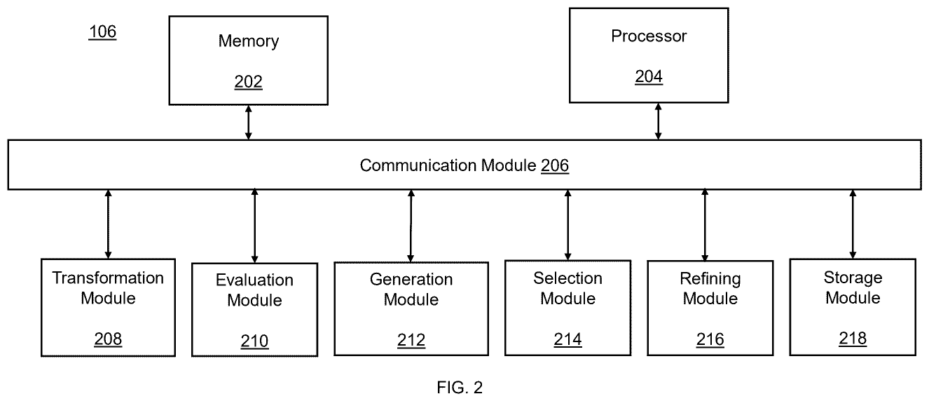

FIG. 2 is a diagram that illustrates the system 102 for optimizing prompts for LLMs, in accordance with an embodiment of the disclosure. Referring to FIG. 2, the system 102 includes a memory 202, a processor 204, a communication module 206, a transformation module 208, an evaluation module 210, a generation module 212, a selection module 214, a refining module 216, and a storage module 218.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 102 in accordance with various aspects of the present disclosure. The communication module 206 is configured to facilitate seamless interaction between the processor 204 and various modules within the system 102.

In one or more embodiments, the system 102 is initially configured to receive the baseline prompt 108 from a user, wherein the baseline prompt 108 comprises a natural language instruction or query formulated for interaction with the LLM 112. The baseline prompt 108 may be user-defined and generally represents an unstructured or semi-structured directive that encapsulates the intended task or question posed to the LLM 112.

In one or more embodiments, the system 102 is configured to include an experimentation component that facilitates both (i) the creation of the baseline prompt 108 through guided and interactive sessions with the user, and (ii) the interaction with the final, refined prompts to obtain accurate and contextually relevant responses from the LLM 112. The experimentation component is designed to assist users such as developers, prompt engineers, or business analysts in formulating initial prompts by leveraging pre-defined templates, contextual cues, and iterative user feedback. Additionally, the experimentation component may present a series of intelligent suggestions, question prompts, or input fields that help the user articulate the intended task, define input-output expectations, and specify any relevant constraints or domain-specific considerations. For interactions with final prompts, the experimentation component may further optimize user queries to maintain contextual relevance.

The transformation module 208 may comprise suitable logic, code, and/or interfaces that are configured to convert the baseline prompt 108 into a structured prompt by applying a standardized architectural framework. The transformation module 208 operates as an intelligent intermediary layer between unstructured user input and the structured formatting required for optimal LLM interaction. The transformation process may include natural language parsing, semantic mapping, and contextual alignment, ensuring that the baseline prompt 108 is decomposed into modular, interpretable components. These components are then reconstructed into a structured format that improves clarity, task relevance, and model interpretability. The transformation module 208 may also leverage domain-specific ontologies, linguistic patterns, and prompt engineering best practices to maintain coherence and alignment with the intended purpose of the prompt.

In one or more embodiments, the standardized architecture framework utilized by the transformation module 208 includes, but is not limited to, core components such as a prompt goal, output constraints, and methodology thinking steps. The prompt goal defines the objective or intent that the prompt is designed to fulfill such as answering a query, classifying a text, or generating creative content. The output constraints are rules or limits placed on the generated response, which may include format specifications, word count limits, stylistic guidelines, or exclusion of certain content. The methodology thinking steps refer to a sequenced, step wise logical structure that the LLM 112 is expected to follow in order to derive the final output. These thinking steps may include reasoning patterns such as “chain-of-thought,” “tree-of-thought,” or customized cognitive workflows that guide the model's internal inference mechanism, thereby enhancing output reliability and traceability.

In one or more embodiments, the standardized architecture framework further incorporates additional critical elements, including a prompt agent, input field types, output field types, and an output persona. The prompt agent defines the role or persona that the large language model is expected to assume when processing the prompt, for example, a medical expert, legal advisor, software architect, or data analyst ensuring that the responses align with domain-specific expectations and tone. Input field types specify the nature and format of inputs to be provided by the user, such as free-text queries, structured data entries, or parameterized controls. Output field types define the structure and data type of the expected response, such as plain text, JSON, tabular data, or bullet-point summaries. The output persona indicates the intended voice or personality with which the model should respond (e.g., formal, conversational, assertive), which further personalizes the user experience and ensures alignment with branding or contextual tone.

In one or more embodiments, transforming the baseline prompt into a structured prompt by the transformation module 208 involves utilizing one or more prompt engineering templates selected from a predefined group comprising few-shot templates, chain of thought templates, tree of thought templates, and custom templates. Each template is designed to instill a specific cognitive or instructional pattern within the prompt.

Few-shot templates embed curated examples directly into the prompt to guide the LLM 112 by demonstration, enabling contextual generalization across similar tasks with minimal training data. Chain of thought templates structure the prompt to explicitly encourage step wise reasoning, allowing the LLM 112 to articulate intermediate steps before arriving at a conclusion, particularly useful in complex reasoning or mathematical tasks. Tree of thought templates further extend this approach by enabling the model to explore multiple branches of reasoning paths simultaneously, effectively supporting deliberation over alternatives before converging on an answer.

Custom templates allow for domain-specific or task-specific adaptations that are fine-tuned to particular operational constraints, such as regulatory language in legal tech applications or empathy-driven language in healthcare scenarios. The transformation module 208 dynamically selects and adapts these templates based on the prompt's objective, user intent, and the anticipated output structure, ensuring that the final structured prompt is both semantically coherent and functionally optimized for interaction with the LLM 112.

In one or more embodiments, transforming the baseline prompt 108 into a structured prompt by the transformation module 208 further involves automatically extracting information from document corpora and incorporating the extracted information into the structured prompt through the use of Prompt Pipelines. The transformation module 208 employs NLP techniques, such as semantic parsing, entity recognition, and document summarization, to analyze extensive textual datasets and extract task-relevant information with minimal manual intervention.

Prompt Pipelines are designed as modular and configurable flows that orchestrate the transformation of raw textual inputs into structured, instruction-ready prompt components. The prompt pipelines automate the abstraction of essential elements such as context, constraints, data formats, role definitions, and methodological cues and inject them into the prompt according to the system's standardized architecture.

In one or more embodiments, the prompt pipelines are dynamically created by selecting a registered baseline prompt from the CPM system 104, which is then subjected to an optimization process triggered upon the detection of new or updated data. The system 102 continuously monitors data sources including structured datasets, unstructured documents, or incoming user inputs for changes that could impact prompt performance or contextual relevance.

Upon identifying such changes, the prompt pipeline invokes one or more optimization algorithms to automate the refinement process. These optimization algorithms may include, but are not limited to, a Bayesian optimization technique and a custom-built Iterative Prompt Optimization Algorithm (IPOA). The refinement process involves updating components such as task-specific instructions, example inputs/outputs, output formatting, and reasoning steps, thereby aligning the prompt with the evolving context of the data.

Thereafter, the system 102 is configured to perform an iterative prompt optimization process. In this process, the system 102 continuously refines and improves the quality and efficacy of structured prompts by leveraging empirical performance data and feedback loops. The iterative prompt optimization process operates over multiple iterations, allowing the system 102 to identify sub-optimal patterns and progressively enhance the prompts in accordance with defined performance metrics. This iterative mechanism ensures that prompts are not only syntactically correct but also semantically aligned with user intent and capable of eliciting accurate and contextually appropriate responses from the LLM 112.

The system 102 is configured to monitor changes or additions to relevant data sources, such as updated document corpora, user feedback logs, or evolving task requirements. When new data is detected, the system 102 automatically triggers a refinement workflow within the prompt pipeline. The workflow applies one or more optimization algorithms, such as Iterative optimization learning, to iteratively enhance the baseline prompt's 108 performance. The refinement process may involve adjusting prompt structure, incorporating updated context, or modifying prompt parameters to maintain or improve response accuracy, efficiency, and relevance. As a result, the prompt pipelines ensure that prompts evolve adaptively with respect to the underlying data, maintaining alignment with the system's 102 performance objectives and domain-specific requirements.

In one or more embodiments, performing the iterative prompt optimization process involves evaluating performance of the structured prompt by the evaluation module 210, against a ground truth dataset comprising a plurality of query-response pairs. The evaluation module 210 may comprise suitable logic, code, and/or interfaces that is configured to evaluate performance of the structured prompt. The evaluation module 210 is configured to compare the outputs generated by the LLM 112, in response to the structured prompt, with the expected responses in the ground truth dataset. This ground truth dataset may be curated to include representative samples across different use cases, domains, or tasks. The evaluation is performed using one or more performance metrics such as BLEU score, ROUGE, F1 score, semantic similarity, or task-specific heuristics, depending on the nature of the prompt.

In one or more embodiments, evaluating performance of the structured prompt includes calculating a Mean Average of Metrics (MAM) score. The MAM score serves as a composite evaluation index that aggregates multiple performance metrics into a unified score to enable consistent comparison and optimization across prompt variations. The individual performance metrics such as answer correctness, relevancy, similarity, and faithfulness are normalized and averaged to compute a base performance value.

The MAM score incorporates time coefficients and cost coefficients to determine optimal prompt variations. In addition to semantic and task-specific evaluation, the MAM score integrates operational considerations by applying weighted coefficients that account for the latency (time to generate a response) and token usage (influencing API cost). Time coefficients reflect the computational efficiency and response time of each prompt variation, while cost coefficients quantify the associated resource utilization in terms of token consumption. By balancing these coefficients with the core performance metrics, the MAM score enables the system 102 to identify prompt configurations that offer an optimal trade-off between output quality, computational efficiency, and economic cost.

In one or more embodiments, performing the iterative prompt optimization process further involves generating a plurality of prompt variations by the generation module 212, for the structured prompt based on performance metrics obtained from the evaluation. The generation module 212 may include suitable logic, code, and/or interfaces that facilitate the intelligent generation of prompt alternatives by utilizing data-driven insights. Based on the feedback derived from the evaluation module 210, the generation module 212 creates prompt variants that modify elements such as instructional phrasing, few-shot examples, output constraints, or methodological reasoning steps.

In one or more embodiments, generating the plurality of prompt variations includes starting an iteration process by a prompt initializer based on the baseline prompt. The prompt initializer initializes the variation loop by leveraging the existing structured baseline prompt. This process begins by invoking a mutation routine to produce new instruction sets that extend or reframe the original prompt's logic and structure.

The generation module 212 further generates instruction sets in batches based on records grouped as clusters of elements from the reference dataset. These clusters represent logically or semantically similar sets of query-response pairs, allowing the system 102 to tailor prompt variations for distinct categories or scenarios. Within each cluster, variations of elemental details such as task objective, format, output tone, or reasoning approach are synthesized using insights mined from the corresponding records in the dataset. These variations are persistently stored and indexed for future reference and comparative evaluation.

Thereafter, the generation module 212 adapts the instruction sets from each cluster into generalized instruction sets. This generalization process involves abstracting prompt-specific patterns into reusable heuristics or modular components. For instance, a chain-of-thought reasoning sequence derived from one cluster may be reformulated into a generalized logic pattern applicable across related tasks, enhancing the modularity and adaptability of the resulting prompts.

Once generalized instruction sets are synthesized, the generation module 212 performs a robust evaluation using performance metrics such as accuracy, relevance, token efficiency, and response consistency. This evaluation incorporates a Bayesian optimization framework, which intelligently explores the trade-off space between token consumption (cost-efficiency) and response quality (performance metrics).

In one or more embodiments, performing the iterative prompt optimization process continues until the refined structured prompt achieves a predetermined performance threshold. The system 102 is configured to perform repeated cycles of evaluation and regeneration of prompt variations until convergence is achieved against a set of target performance metrics. The performance threshold may be dynamically defined based on task-specific requirements, organizational standards, or user-defined constraints. During each iteration, the evaluation module 210 measures the effectiveness of the current prompt variation, and if the measured performance does not meet the threshold, the generation module 212 continues to produce further variations using adaptive logic and learned heuristics. This iterative loop ensures that only prompts demonstrating consistent high-quality output across diverse scenarios are retained and finalized for deployment.

In some non-limiting embodiments, the predetermined performance threshold for evaluating the effectiveness of the structured prompt may, by default, be set to a value of 0.5, which corresponds to a 50% improvement in the mean average of selected performance metrics. These metrics may include, for example, accuracy, relevance, coherence, completeness, or any other quantitative or qualitative indicators deemed appropriate for the target task. The threshold serves as a baseline benchmark to determine whether the refined structured prompt exhibits a significant enhancement over the initial or baseline prompt.

In some non-limiting embodiments, the predetermined performance threshold is not fixed and may be set to values other than 0.5, depending on specific use cases, performance expectations, or domain constraints. For instance, in high-stakes applications requiring greater precision such as legal, medical, or financial domains the threshold may be raised to 0.7 or higher to ensure stringent quality control. Conversely, for exploratory or creative tasks, a lower threshold such as 0.3 may be acceptable to encourage a broader range of prompt variations.

In one or more embodiments, the performance metrics comprise at least two metrics selected from a group consisting of answer relevancy, answer correctness, answer faithfulness, answer similarity, answer exact match, and answer passage match. These metrics collectively enable a multi-dimensional assessment of the quality and reliability of LLM-generated responses. Answer relevancy evaluates whether the response directly addresses the query context. Answer correctness verifies the factual accuracy based on a ground truth dataset. Answer faithfulness measures alignment between the LLM output and underlying reasoning or source information to ensure no hallucinations are present. Answer similarity and answer exact match compare the generated output with reference responses at a semantic and token level, respectively. Answer passage match checks whether the generated response correctly extracts or synthesizes relevant information from a provided passage or document.

In some non-limiting embodiments, the generation module 212 generates the plurality of prompt variations for the structured prompt across a range of complexity levels. These complexity levels may include, but are not limited to, variations in syntactic structure, lexical richness, contextual elaboration, and inclusion of domain-specific terminology. Additionally, the complexity levels may extend to structural aspects of the prompt, such as the number of steps in the methodology, inclusion or exclusion of output personas, specification of roles, application of constraints, and formatting of outputs. For instance, the generation module 212 may apply predefined transformation rules, machine learning techniques, or prompt engineering heuristics to systematically modify the structured prompt while preserving its core intent.

In one or more embodiments, performing the iterative prompt optimization process further involves selecting one or more optimal prompt variations using computational optimization algorithms that maximize the performance metrics, by the selection module 214 which comprises suitable logic, code, and/or interfaces.

In some non-limiting embodiments, the computational optimization algorithms comprise Bayesian optimization. Bayesian optimization is particularly well-suited for optimizing high-dimensional, non-convex spaces such as those involved in prompt tuning, as it leverages probabilistic modeling (e.g., Gaussian Processes) to estimate the performance landscape and iteratively select the most promising prompt variations for evaluation. This allows for efficient exploration and exploitation of the prompt space with fewer iterations compared to exhaustive search techniques.

However, the computational optimization algorithms used in the present disclosure may not be limited to Bayesian optimization. Depending on the complexity of the prompt structure, dataset characteristics, and performance criteria, the system 102 may alternatively or additionally employ other optimization techniques, such as evolutionary algorithms, reinforcement learning-based optimization, gradient-free methods, or grid/random search strategies.

In one or more embodiments, performing the iterative prompt optimization process further involves refining the structured prompt by incorporating elements from one or more optimal prompt variations, by the refining module 216. The refining module 216 may comprise suitable logic, code, and/or interfaces configured to systematically integrate high-performing prompt components such as exemplary instruction sets, effective phrasing, or optimized parameter constraints into the existing structured prompt. This integration process is informed by comparative performance metrics derived from the evaluation module and guided by optimization heuristics.

In one or more embodiments, performing the iterative prompt optimization process further involves decomposing complex prompts into prompt sequences and optimizing the prompt sequences. This decomposition strategy enables the system 102 to transform a monolithic or overloaded prompt into a sequence of modular, task-specific sub-prompts, each representing a logically isolated operation or instruction. These sub-prompts, collectively referred to as a prompt sequence, are then individually optimized through the same iterative methodology, evaluated for performance, varied for effectiveness, and refined for efficiency.

The storage module 218 may comprise suitable logic, code, and/or interfaces that may be configured to store the refined structured prompt in the CPM system 104, which is responsible for maintaining version control across a plurality of prompts. In particular, once the structured prompt has undergone iterative optimization and refinement, it persisted within the CPM system 104 to ensure traceability, reusability, and governance. Versioning enables developers and system administrators to track historical changes, compare performance across prompt iterations, and the rollback to previously validated versions if necessary.

In one or more embodiments, the CPM system 104 comprises a dashboard interface that facilitates prompt structuring, templatizing, versioning, and key performance indicator (KPI) reporting. The dashboard interface serves as an interactive control panel that allows users such as developers, data scientists, and domain experts to manage the full prompt engineering workflow. Through the dashboard interface, the user is also enabled to define structured templates, apply metadata tags, create prompt variants, monitor optimization progress, and view performance metrics such as answer relevancy, accuracy, and response latency. KPI reporting is designed to provide actionable insights into how different prompt configurations perform over time, thus enabling data-driven decision-making in prompt engineering and deployment.

The user interface 106 serves as the primary point of interaction between the user and the system 102, allowing users to input queries, receive responses, and engage in iterative prompt-based exchanges with the underlying LLM. The refined structured prompt generated and optimized through the system's 102 backend modules, is utilized within this user interface 106 to drive accurate, context-aware, and semantically rich responses from the LLM.

In some non-limiting embodiments, the user interface 106 may also support various modes of interaction, including text, voice, or multimodal input, thereby enhancing the accessibility and flexibility of the system.

The prompt personas are predefined roles or behavioral profiles assigned to the LLM within the structured prompt to simulate domain-specific expertise or user-aligned conversational tones. Each interactive persona may encapsulate context, tone, reasoning strategies, and response behavior that align with specific user intents or operational scenarios such as a legal advisor, customer support agent, technical assistant, or creative collaborator. The system 102 dynamically adjusts these personas during runtime based on user inputs and contextual signals, allowing for more personalized and effective interactions.

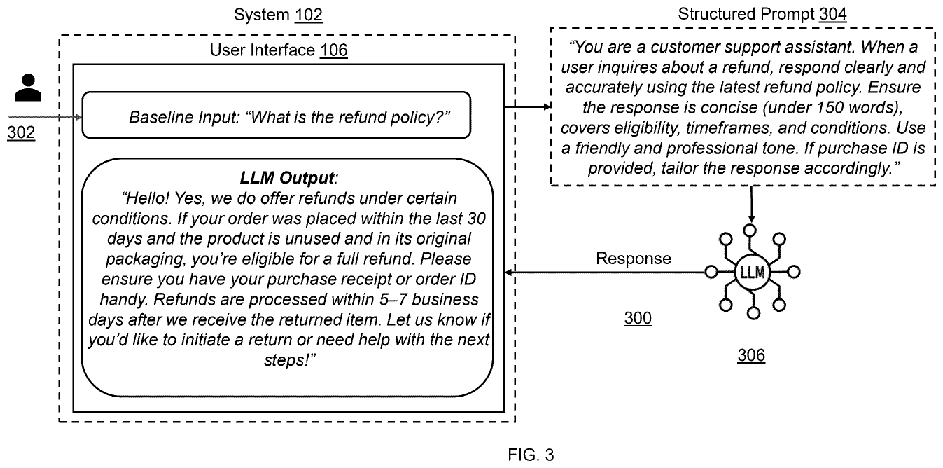

FIG. 3 is an exemplary diagram 300 that illustrates interaction of a user with an LLM via the system 102, in accordance with an embodiment of the disclosure. Referring to FIG. 3, the diagram 300 comprises a developer 302, the system 102, the user interface 106, a structured prompt 304, and an LLM 306

In accordance with the exemplary diagram 300, consider a developer 302 working in a customer support automation platform who intends to use an LLM to generate helpful answers for users asking about refund policies. The developer 302 provides the following baseline prompt to the system 102 via the user interface 106:
“What is the refund policy?”

While this prompt is valid, it lacks contextual clarity, constraints, or role definition. The system 102 is configured to enhance this input baseline prompt through a structured and iterative optimization pipeline as described below:

The transformation module 208 first processes the baseline prompt to convert it into a structured prompt using a standardized architecture. This architecture may include:
Prompt Goal: Retrieve accurate and customer-friendly refund policy information.
Output Constraints: Limit response to 150 words; avoid generic statements.
Methodological Thinking Steps: Retrieve relevant policy section→Summarize in simple terms→Format response conversationally.
Prompt Agent Role: “You are a customer service agent.”
Input/Output Field Types: Input=customer query; Output=policy explanation.
Output Persona: Friendly, concise, and professional.

The transformation module 208 may also apply a few-shot prompt engineering template that includes two example queries and responses related to shipping policies and cancellation procedures, providing the LLM with a frame of reference.

The structured prompt is then evaluated against a ground truth dataset consisting of multiple user queries and ideal refund-related responses. The evaluation metrics include:
Answer relevancy
Answer correctness
Answer similarity (to ideal answer)
Mean Average of Metrics (MAM) score, which also incorporates time and cost coefficients.

For instance, the system 102 may find that the current structured prompt only achieves a 72% MAM score due to vagueness or overuse of tokens.

Based on performance feedback, the generation module 212 initiates an iterative process to create a plurality of prompt variations. This involves:
Activating a prompt initializer with the baseline prompt as the seed.
Clustering records from the reference dataset (e.g., various refund scenarios).
Creating methodological instruction sets based on the cluster elements.
Generalizing the instruction sets to cover a broader range of refund policy queries.

These are passed through a Bayesian optimization routine which considers trade-offs between token usage and accuracy to rank the prompts.

The selection module 214 then evaluates the newly generated prompt variations and identifies the top-performing ones. For example:
Variation A: “You are a customer support agent. When a user asks about refund policies, provide a concise summary based on the latest policy document. Limit the response to under 150 words.”
Variation B: “Act as a policy assistant. When asked, explain the refund conditions clearly and refer to the customer's purchase date and receipt availability.”

These variations are compared with the same metrics, and one is selected as optimal.

The refining module 216 takes the selected optimal variation and incorporates effective elements from other high-performing variations to construct a refined structured prompt. It may also:
Add dynamic slots for integrating context (e.g., purchase ID or date).
Decompose complex refund scenarios into prompt sequences (e.g., eligibility check→refund method→processing time).

The final refined structured prompt 304 is then stored in the CPM system 104, which:
Maintains version control for this refined prompt.
Records associated KPIs (e.g., MAM score, token usage).
Supports template reuse, audit trails, and prompt lineage.

This refined prompt is now accessible via the user interface 106, enabling customer support bots or agents to directly interact with users through the LLM.

### Final Structured Prompt

“You are a customer support assistant. When a user inquiries about a refund, they respond clearly and accurately using the latest refund policy. Ensure the response is concise (under 150 words), covers eligibility, timeframes, and conditions. Use a friendly and professional tone. If purchase ID is provided, tailor the response accordingly.”

### LLM Output

“Hello! Yes, we do offer refunds under certain conditions. If your order was placed within the last 30 days and the product is unused and in its original packaging, you're eligible for a full refund. Please ensure you have your purchase receipt or order ID handy. Refunds are processed within 5-7 business days after we receive the returned item. Let us know if you'd like to initiate a return or need help with the next steps!”

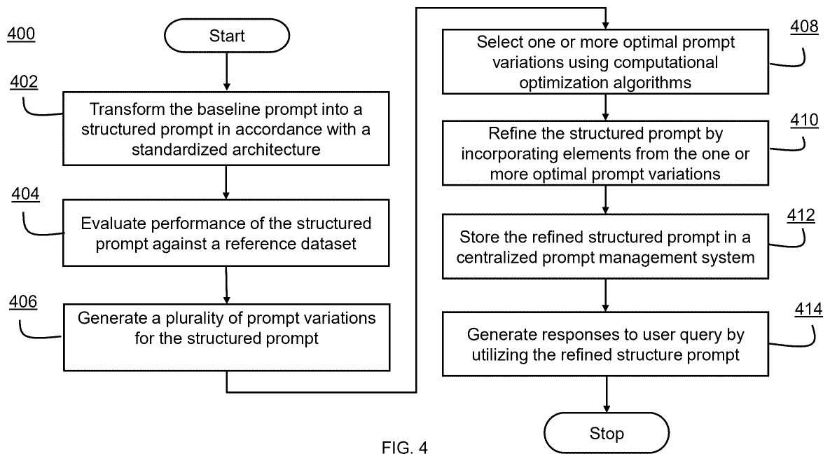

FIG. 4 is a diagram that illustrates a flowchart 400 with a method for optimizing prompts for the LLMs, in accordance with an embodiment of the disclosure.

In one or more embodiments, the system 102 is initially configured to receive the baseline prompt 108 from a user, wherein the baseline prompt 108 comprises a natural language instruction or query formulated for interaction with the LLM 112. The baseline prompt 108 may be user-defined and generally represents an unstructured or semi-structured directive that encapsulates the intended task or question posed to the LLM 112.

In one or more embodiments, the system 102 is configured to include an experimentation component that facilitates both (i) the creation of the baseline prompt 108 through guided and interactive sessions with the user, and (ii) the interaction with the final, refined prompts to obtain accurate and contextually relevant responses from the LLM 112. The experimentation component is designed to assist users such as developers, prompt engineers, or business analysts in formulating initial prompts by leveraging pre-defined templates, contextual cues, and iterative user feedback. Additionally, the experimentation component may present a series of intelligent suggestions, question prompts, or input fields that help the user articulate the intended task, define input-output expectations, and specify any relevant constraints or domain-specific considerations. For interactions with final prompts, the experimentation component may further optimize user queries to maintain contextual relevance.

At 402, the transformation module 208 transforms the baseline prompt into a structured prompt in accordance with a standardized architecture. The transformation module 208 operates as an intelligent intermediary layer between unstructured user input and the structured formatting required for optimal LLM interaction. The transformation process may include natural language parsing, semantic mapping, and contextual alignment, ensuring that the baseline prompt 108 is decomposed into modular, interpretable components. These components are then reconstructed into a structured format that improves clarity, task relevance, and model interpretability. The transformation module 208 may also leverage domain-specific ontologies, linguistic patterns, and prompt engineering best practices to maintain coherence and alignment with the intended purpose of the prompt.

In one or more embodiments, the standardized architecture framework utilized by the transformation module 208 includes, but is not limited to, core components such as a prompt goal, output constraints, and methodology thinking steps. The prompt goal defines the objective or intent that the prompt is designed to fulfill such as answering a query, classifying a text, or generating creative content. The output constraints are rules or limits placed on the generated response, which may include format specifications, word count limits, stylistic guidelines, or exclusion of certain content. The methodology thinking steps refer to a sequenced, step wise logical structure that the LLM 112 is expected to follow in order to derive the final output. These thinking steps may include reasoning patterns such as “chain-of-thought,” “tree-of-thought,” or customized cognitive workflows that guide the model's internal inference mechanism, thereby enhancing output reliability and traceability.

In one or more embodiments, the standardized architecture framework further incorporates additional critical elements, including a prompt agent, input field types, output field types, and an output persona. The prompt agent defines the role or persona that the large language model is expected to assume when processing the prompt, for example, a medical expert, legal advisor, software architect, or data analyst ensuring that the responses align with domain-specific expectations and tone. Input field types specify the nature and format of inputs to be provided by the user, such as free-text queries, structured data entries, or parameterized controls. Output field types define the structure and data type of the expected response, such as plain text, JSON, tabular data, or bullet-point summaries. The output persona indicates the intended voice or personality with which the model should respond (e.g., formal, conversational, assertive), which further personalizes the user experience and ensures alignment with branding or contextual tone.

In one or more embodiments, transforming the baseline prompt into a structured prompt by the transformation module 208 involves utilizing one or more prompt engineering templates selected from a predefined group comprising few-shot templates, chain of thought templates, tree of thought templates, and custom templates. Each template is designed to instill a specific cognitive or instructional pattern within the prompt.

Thereafter, the system 102 is configured to perform an iterative prompt optimization process. In this process, the system 102 continuously refines and improves the quality and efficacy of structured prompts by leveraging empirical performance data and feedback loops. The iterative prompt optimization process operates over multiple iterations, allowing the system 102 to identify sub-optimal patterns and progressively enhance the prompts in accordance with defined performance metrics. This iterative mechanism ensures that prompts are not only syntactically correct but also semantically aligned with user intent and capable of eliciting accurate and contextually appropriate responses from the LLM 112.

The system 102 is configured to monitor changes or additions to relevant data sources, such as updated document corpora, user feedback logs, or evolving task requirements. When new data is detected, the system 102 automatically triggers a refinement workflow within the prompt pipeline. The workflow applies one or more optimization algorithms, such as Bayesian optimization or reinforcement learning, to iteratively enhance the baseline prompt's 108 performance. The refinement process may involve adjusting prompt structure, incorporating updated context, or modifying prompt parameters to maintain or improve response accuracy, efficiency, and relevance. As a result, the prompt pipelines ensure that prompts evolve adaptively with respect to the underlying data, maintaining alignment with the system's 102 performance objectives and domain-specific requirements.

At 404, performance of the structured prompt is evaluated against a reference dataset comprising a plurality of query-response pairs to obtain performance metrics, by the evaluation module 210. The evaluation module 210 is configured to compare the outputs generated by the LLM 112, in response to the structured prompt, with the expected responses in the ground truth dataset. This ground truth dataset may be curated to include representative samples across different use cases, domains, or tasks. The evaluation is performed using one or more performance metrics such as BLEU score, ROUGE, F1 score, semantic similarity, or task-specific heuristics, depending on the nature of the prompt.

In one or more embodiments, evaluating performance of the structured prompt includes calculating a Mean Average of Metrics (MAM) score. The MAM score serves as a composite evaluation index that aggregates multiple performance metrics into a unified score to enable consistent comparison and optimization across prompt variations. The individual performance metrics such as answer correctness, relevancy, similarity, and faithfulness are normalized and averaged to compute a base performance value.

The MAM score incorporates time coefficients and cost coefficients to determine optimal prompt variations. In addition to semantic and task-specific evaluation, the MAM score integrates operational considerations by applying weighted coefficients that account for the latency (time to generate a response) and token usage (influencing API cost). Time coefficients reflect the computational efficiency and response time of each prompt variation, while cost coefficients quantify the associated resource utilization in terms of token consumption. By balancing these coefficients with the core performance metrics, the MAM score enables the system 102 to identify prompt configurations that offer an optimal trade-off between output quality, computational efficiency, and economic cost.

At 406, the generation module 212 generates a plurality of prompt variations for the structured prompt based on performance metrics obtained from the evaluation. Based on the feedback derived from the evaluation module 210, the generation module 212 creates prompt variants that modify elements such as instructional phrasing, few-shot examples, output constraints, or methodological reasoning steps.

In one or more embodiments, generating the plurality of prompt variations includes starting an iteration process by a prompt initializer based on the baseline prompt. The prompt initializer acts as a foundational engine that initializes the variation loop by leveraging the existing structured baseline prompt. This process begins by invoking a mutation routine to produce new methodological instruction sets that extend or reframe the original prompt's logic and structure.

The generation module 212 further generates methodological instruction sets in batches based on records grouped as clusters of elements from the reference dataset. These clusters represent logically or semantically similar sets of query-response pairs, allowing the system 102 to tailor prompt variations for distinct categories or scenarios. Within each cluster, variations of elemental details such as task objective, format, output tone, or reasoning approach are synthesized using insights mined from the corresponding records in the dataset. These variations are persistently stored and indexed for future reference and comparative evaluation.

Thereafter, the generation module 212 adapts the instruction sets from each cluster into generalized instruction sets. This generalization process involves abstracting prompt-specific patterns into reusable heuristics or modular components. For instance, a chain-of-thought reasoning sequence derived from one cluster may be reformulated into a generalized logic pattern applicable across related tasks, enhancing the modularity and adaptability of the resulting prompts.

Once generalized instruction sets are synthesized, the generation module 212 performs a robust evaluation using performance metrics such as accuracy, relevance, token efficiency, and response consistency. This evaluation incorporates a Bayesian optimization framework, which intelligently explores the trade-off space between token consumption (cost-efficiency) and response quality (performance metrics).

In one or more embodiments, performing the iterative prompt optimization process continues until the refined structured prompt achieves a predetermined performance threshold. The system 102 is configured to perform repeated cycles of evaluation and regeneration of prompt variations until convergence is achieved against a set of target performance metrics. The performance threshold may be dynamically defined based on task-specific requirements, organizational standards, or user-defined constraints. During each iteration, the evaluation module 210 measures the effectiveness of the current prompt variation, and if the measured performance does not meet the threshold, the generation module 212 continues to produce further variations using adaptive logic and learned heuristics. This iterative loop ensures that only prompts demonstrating consistent high-quality output across diverse scenarios are retained and finalized for deployment.

In one or more embodiments, the performance metrics comprise at least two metrics selected from a group consisting of answer relevancy, answer correctness, answer faithfulness, answer similarity, answer exact match, and answer passage match. These metrics collectively enable a multi-dimensional assessment of the quality and reliability of LLM-generated responses. Answer relevancy evaluates whether the response directly addresses the query context. Answer correctness verifies the factual accuracy based on a ground truth dataset. Answer faithfulness measures alignment between the LLM output and underlying reasoning or source information to ensure no hallucinations are present. Answer similarity and answer exact match compare the generated output with reference responses at a semantic and token level, respectively. Answer passage match checks whether the generated response correctly extracts or synthesizes relevant information from a provided passage or document.

At 408, one or more optimal prompt variations are selected by the selection module 214 using computational optimization algorithms that maximize the performance metrics.

In some non-limiting embodiments, the computational optimization algorithms comprise Bayesian optimization. Bayesian optimization is particularly well-suited for optimizing high-dimensional, non-convex spaces such as those involved in prompt tuning, as it leverages probabilistic modeling (e.g., Gaussian Processes) to estimate the performance landscape and iteratively select the most promising prompt variations for evaluation. This allows for efficient exploration and exploitation of the prompt space with fewer iterations compared to exhaustive search techniques.

However, the computational optimization algorithms used in the present disclosure may not be limited to Bayesian optimization. Depending on the complexity of the prompt structure, dataset characteristics, and performance criteria, the system 102 may alternatively or additionally employ other optimization techniques, such as evolutionary algorithms, reinforcement learning-based optimization, gradient-free methods, or grid/random search strategies.

At 410, the refining module 216 refines the structured prompt by incorporating elements from the one or more optimal prompt variations. The refining module 216 may comprise suitable logic, code, and/or interfaces configured to systematically integrate high-performing prompt components such as exemplary instruction sets, effective phrasing, or optimized parameter constraints into the existing structured prompt. This integration process is informed by comparative performance metrics derived from the evaluation module and guided by optimization heuristics.

In one or more embodiments, performing the iterative prompt optimization process further involves decomposing complex prompts into prompt sequences and optimizing the prompt sequences. This decomposition strategy enables the system 102 to transform a monolithic or overloaded prompt into a sequence of modular, task-specific sub-prompts, each representing a logically isolated operation or instruction. These sub-prompts, collectively referred to as a prompt sequence, are then individually optimized through the same iterative methodology, evaluated for performance, varied for effectiveness, and refined for efficiency.

The system 102 is further configured to store the refined structured prompt in the CPM system 104, which is responsible for maintaining version control across a plurality of prompts. In particular, once the structured prompt has undergone iterative optimization and refinement, it persisted within the CPM system 104 to ensure traceability, reusability, and governance. Versioning enables developers and system administrators to track historical changes, compare performance across prompt iterations, and the rollback to previously validated versions if necessary.

In one or more embodiments, the CPM system 104 comprises a dashboard interface that facilitates prompt structuring, templatizing, versioning, and key performance indicator (KPI) reporting. The dashboard interface serves as an interactive control panel that allows users such as developers, data scientists, and domain experts to manage the full prompt engineering workflow. Through the dashboard interface, the user is also enabled to define structured templates, apply metadata tags, create prompt variants, monitor optimization progress, and view performance metrics such as answer relevancy, accuracy, and response latency. KPI reporting is designed to provide actionable insights into how different prompt configurations perform over time, thus enabling data-driven decision-making in prompt engineering and deployment.

In particular, the user interface 106 serves as the primary point of interaction between the user and the system 102, allowing users to input queries, receive responses, and engage in iterative prompt-based exchanges with the underlying LLM. The refined structured prompt generated and optimized through the system's 102 backend modules, is utilized within this user interface 106 to drive accurate, context-aware, and semantically rich responses from the LLM.

In some non-limiting embodiments, the user interface 106 may also support various modes of interaction, including text, voice, or multimodal input, thereby enhancing the accessibility and flexibility of the system.

At 412, the storage module 218 stores the refined structured prompt in the CPM system 104 that maintains version control for a plurality of prompts. In particular, once the structured prompt has undergone iterative optimization and refinement, it persisted within the CPM system 104 to ensure traceability, reusability, and governance. Versioning enables developers and system administrators to track historical changes, compare performance across prompt iterations, and the rollback to previously validated versions if necessary.

In one or more embodiments, the CPM system 104 comprises a dashboard interface that facilitates prompt structuring, templatizing, versioning, and key performance indicator (KPI) reporting. The dashboard interface serves as an interactive control panel that allows users such as developers, data scientists, and domain experts to manage the full prompt engineering workflow. Through the dashboard interface, the user is also enabled to define structured templates, apply metadata tags, create prompt variants, monitor optimization progress, and view performance metrics such as answer relevancy, accuracy, and response latency. KPI reporting is designed to provide actionable insights into how different prompt configurations perform over time, thus enabling data-driven decision-making in prompt engineering and deployment.

At 414, the system provides enables users to interact with the LLM using the refined structured prompt via the user interface 106. The user interface 106 utilizes the refined structured prompt to generate responses to user queries.

The user interface 106 serves as the primary point of interaction between the user and the system 102, allowing users to input queries, receive responses, and engage in iterative prompt-based exchanges with the underlying LLM. The refined structured prompt generated and optimized through the system's 102 backend modules, is utilized within this user interface 106 to drive accurate, context-aware, and semantically rich responses from the LLM.

In some non-limiting embodiments, the user interface 106 may also support various modes of interaction, including text, voice, or multimodal input, thereby enhancing the accessibility and flexibility of the system.

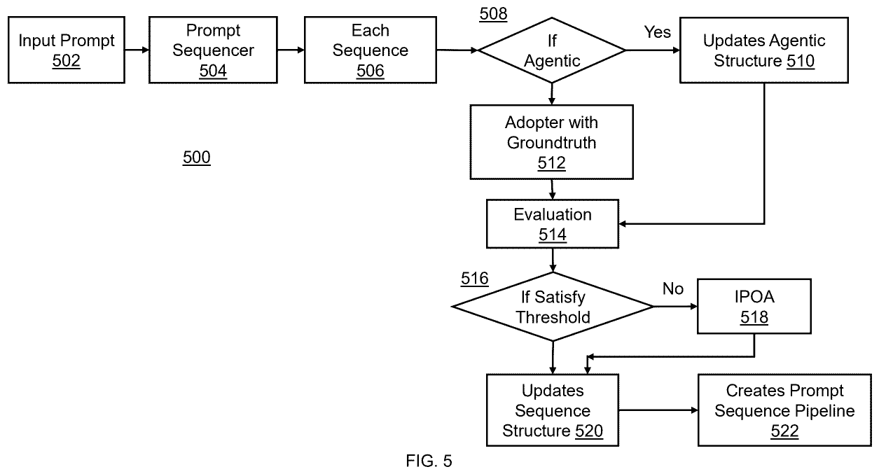

FIG. 5 is a diagram that illustrates a workflow 500 for creating prompt sequence pipeline, in accordance with an embodiment of the disclosure.

In one or more embodiments, the system 102 is configured to initiate the construction of a prompt sequence pipeline by first receiving an input prompt 502. The input prompt 502 may be a natural language instruction, query, or directive, either user-defined or system-generated, intended to elicit a specific type of output from an LLM.

Upon receiving the input prompt, the system 102 utilizes a prompt sequencer 504 to deconstruct the input prompt 502 into a series of discrete and logically ordered sub-prompts or sequences 506. Each sequence 506 represents a task-specific unit of execution, such as a sub-question, intermediate computation, verification check, or formatting instruction. The prompt sequencer 504 applies syntactic parsing, semantic segmentation, and intent analysis to ensure that the resulting sequences retain contextual coherence.

In one or more embodiments, for each generated sequence 506, the system 102 evaluates whether the sequence exhibits agentic characteristics 508. A sequence is considered agentic if it requires or benefits from the LLM assuming a defined role or persona to perform domain-specific reasoning or contextual alignment. If the sequence is identified as agentic, the system 102 augments it by integrating an agentic structure 510, which may include persona definitions, behavioral constraints, tone modulation, or role-based output expectations.

After agentic structuring, the system 102 further enhances the sequence using a groundtruth adopter 512. The groundtruth adopter 512 incorporates reference information, such as verified answers, curated exemplars, or gold-standard instructions relevant to the sequence's task domain. By embedding this authoritative context, the system 102 ensures that each sequence 506 is grounded in reliable information and can guide the LLM toward accurate and faithful responses.

In one or more embodiments, the enhanced sequence is then passed through an evaluation module 514, which determines whether the sequence satisfies a defined performance threshold 516. The evaluation is conducted using one or more metrics such as accuracy, semantic similarity, task completeness, or alignment with expected groundtruth outputs. If the sequence fails to meet the threshold 516, it may be sent back for further augmentation or rejected from inclusion in the pipeline. If the sequence does meet or exceed the threshold 516, the system 102 proceeds with refinement.

For sequences that pass the evaluation threshold 516, the system 102 invokes the IPOA 518. IPOA 518 iteratively fine-tunes the sequence by applying a combination of rule-based heuristics, performance feedback loops, and statistical optimization techniques to maximize prompt effectiveness. The refinement process may adjust linguistic phrasing, logical flow, structural dependencies, or contextual framing to further enhance the sequence's clarity, utility, and model interpretability.

Following refinement by IPOA 518, the system 102 updates the sequence structure 520. The update may include changes to the internal modular design of the sequence, such as altering stepwise reasoning flow, modifying data constraints, or realigning expected input-output mappings.

In one or more embodiments, once all sequences have been individually processed, evaluated, and optimized, the system 102 aggregates them to create the prompt sequence pipeline 522. The resulting prompt sequence pipeline 522 comprises an ordered, modular sequence of prompts that work collaboratively to execute complex instructions through multiple LLM interactions. The prompt sequence pipeline 522 is then ready for deployment and may be used in workflows requiring high accuracy, modularity, and interpretability such as multi-stage question answering, document summarization with constraints, or policy-driven content generation.

The present disclosure offers a technically robust framework for optimizing prompts used in the LLMs, addressing key limitations in existing manual and ad hoc approaches. By incorporating modular components such as transformation, evaluation, generation, selection, and refinement modules, the system enables automated, iterative optimization of prompts based on performance metrics. It further supports standardized prompt architectures, dynamic prompt pipelines responsive to new data, and version-controlled management through a CPM system. This leads to enhanced prompt accuracy, consistency, scalability, and adaptability across diverse domains, making the method and system superior in both efficiency and performance compared to conventional prompt engineering methods.

The present disclosure leverages adaptive machine learning techniques to iteratively refine and optimize prompts based on observed performance metrics such as relevance, correctness, and faithfulness. By continuously analyzing response quality and feedback signals, the system dynamically adjusts prompt structures and content to align with contextual expectations and user intent. This adaptive mechanism ensures that prompts remain effective across varying tasks and domains. Additionally, the use of performance-driven feedback loops allows the system to learn and evolve over time, reducing manual effort in prompt engineering. As a result, the disclosure significantly improves the precision and efficiency of interactions with large language models.

The present disclosure introduces interactive personas that enable personalized and context-aware interactions between users and large language models. These personas are dynamically configured based on user roles, tasks, and communication preferences, ensuring that the responses generated are not only relevant but also aligned with the user's intent and tone. By simulating domain-specific agents or roles, the system can guide conversations more effectively and deliver nuanced outputs. This enhances user engagement and improves the usability of prompt-based systems across diverse use cases. The integration of interactive personas adds a layer of semantic richness and adaptability, making AI interactions more natural and goal oriented.

The present disclosure offers a high degree of automation across the prompt lifecycle, significantly minimizing the need for manual intervention. From the transformation of baseline prompts into structured formats to iterative optimization using performance metrics, each stage is automated using intelligent modules. Automated training leverages document corpora and preconfigured templates to enrich prompts, while inference and evaluation processes utilize algorithmic models to assess and refine outputs. This not only accelerates the prompt development cycle but also ensures consistency, scalability, and reliability across use cases, making the system highly efficient and developer friendly.

The present disclosure introduces a cost-efficient prompt optimization approach by minimizing unnecessary token usage while preserving essential information. Through structured prompt transformation, intelligent decomposition into prompt sequences, and iterative refinement based on performance metrics, the system ensures that only the most relevant and high-utility content is retained. This leads to reduced API call sizes and lower computational costs during LLM interactions, making the prompt management process economically viable without sacrificing output quality or fidelity.

The present disclosure incorporates an iterative prompt optimization algorithm that enables continuous refinement of prompts to achieve optimal performance. By systematically evaluating prompt outputs against predefined performance metrics such as answer relevance, correctness, and similarity the system identifies areas of improvement. It then generates prompt variations using algorithmic strategies like Bayesian optimization, selects the most effective versions, and integrates their elements into the structured prompt. This iterative loop continues until a target performance threshold is met, ensuring that prompts are both efficient in structure and effective in eliciting high-quality responses from LLMs.

The present disclosure integrates Bayesian optimization with enhanced evaluation metrics such as Mean Average of Metrics (MAM), time coefficients, and cost coefficients to drive more accurate and efficient prompt optimization. This multi-dimensional optimization framework enables the system to balance response quality with practical constraints like latency and computational cost. Unlike conventional methods that focus on a single metric or static evaluation, the system's approach ensures a holistic and context-aware refinement of prompts, leading to superior LLM interactions that are both cost-effective and performance-optimized.

The present disclosure leverages a ground truth dataset to iteratively train and refine baseline prompts, generating and evaluating methodological instruction sets across real-world scenarios. This data-driven methodology ensures that prompt optimization is not based on assumptions or static rules, but on measurable performance outcomes. By systematically incorporating empirical feedback from actual query-response records, the disclosure enhances the contextual relevance, precision, and robustness of structured prompts. This approach leads to more accurate and effective interactions with LLMs, setting the system apart from conventional, less adaptive solutions.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for optimizing prompts for large language models, the system comprising:
a processor;
a memory storing an instruction set that, when executed by the processor, cause the processor to:
receive a baseline prompt configured for interacting with a large language model;
transform the baseline prompt into a structured prompt in accordance with a standardized architecture comprising at least one of a prompt goal, output constraints, and methodology thinking steps defining a sequential process for deriving outputs;
perform an iterative prompt optimization process, wherein the iterative prompt optimization process comprises:
evaluating performance of the structured prompt against a reference dataset comprising a plurality of query-response pairs;
generating a plurality of prompt variations in different complexity levels for the structured prompt based on a performance metrics obtained from the evaluation;
selecting one or more optimal prompt variations using computational optimization algorithms that maximize the performance metrics;
refining the structured prompt by incorporating elements from the one or more optimal prompt variations;
store the refined structured prompt in a centralized prompt management system that maintains version control for a plurality of prompts; and
provide a user interface that enables users to interact with the large language model using the refined structured prompt, wherein the user interface utilizes the refined structured prompt to generate responses to user queries.

2. The system of claim 1, wherein the memory further stores instructions that, when executed by the processor, cause the processor to provide an experimentation component configured to build the baseline prompt through guided interactions with a user.

3. The system of claim 1, wherein the standardized architecture further comprises a prompt agent defining a role for the large language model, input field types, output field types, and an output persona.

4. The system of claim 1, wherein transforming the baseline prompt into a structured prompt comprises utilizing one or more prompt engineering templates selected from a group consisting of: few-shot templates, chain of thought templates, tree of thought templates, and custom templates.

5. The system of claim 1, wherein generating the plurality of prompt variations comprises:
starting an iteration process by a prompt initializer based on the baseline prompt;
generating methodological instruction sets in batches based on records as cluster of elements from the reference dataset, wherein variation of elemental details are stored in the corresponding cluster set by using information from the reference dataset;
adapting the generated instruction sets from the cluster of elements to create generalized instruction sets; and
evaluating the generalized instruction sets using the performance metrics, which performs Bayesian optimization to get a prompt considering token and evaluation scores as trade off factor and reranking prompts to provide final instruction sets.

6. The system of claim 1, wherein the iterative prompt optimization process continues until the refined structured prompt achieves a predetermined performance threshold.

7. The system of claim 1, wherein the performance metrics comprise at least two metrics selected from a group consisting of: answer relevancy, answer correctness, answer faithfulness, answer similarity, answer exact match, and answer passage match.

8. The system of claim 1, wherein evaluating performance of the structured prompt comprises calculating a Mean Average of Metrics (MAM) score.

9. The system of claim 8, wherein the MAM score incorporates time coefficients and cost coefficients to determine optimal prompt variations.

10. The system of claim 1, wherein the computational optimization algorithms comprise Bayesian optimization.

11. The system of claim 1, wherein performing the iterative prompt optimization process further comprises decomposing complex prompts into prompt sequences and optimizing the prompt sequences.

12. The system of claim 1, wherein transforming the baseline prompt (108) into a structured prompt comprises:
automatically extracting information from document corpora; and
incorporating the extracted information into the structured prompt with prompt pipelines.

13. The system of claim 1, wherein the centralized prompt management system comprises a dashboard interface that facilitates prompt structuring, templatizing, versioning, and key performance indicator reporting.

14. The system of claim 1, wherein the memory further stores instructions that, when executed by the processor, cause the processor to provide interactive prompt personas that enable dynamic and adaptable interactions with users.

15. The system of claim 1, wherein the prompt pipelines are created by choosing a registered baseline prompt which refines the prompt using an optimization algorithm, when new data is detected.

16. A computer-implemented method for optimizing prompts for large language models, the method comprising:
receiving a baseline prompt configured for interacting with a large language model;
transforming the baseline prompt into a structured prompt in accordance with a standardized architecture comprising at least a prompt goal, output constraints, and methodology thinking steps defining a sequential process for deriving outputs;
performing an iterative prompt optimization process, wherein the iterative prompt optimization process comprises:
evaluating performance of the structured prompt against a reference dataset comprising a plurality of query-response pairs to obtain performance metrics;
generating a plurality of prompt variations in different complexity levels for the structured prompt based on performance metrics obtained from the evaluation;
selecting one or more optimal prompt variations using computational optimization algorithms that maximize the performance metrics;
refining the structured prompt by incorporating elements from the one or more optimal prompt variations;
storing the refined structured prompt in a centralized prompt management system that maintains version control for a plurality of prompts; and
providing a user interface that enables users to interact with the large language model using the refined structured prompt, wherein the user interface utilizes the refined structured prompt to generate responses to user queries.

17. The method of claim 16, wherein the standardized architecture further comprises a prompt agent defining a role for the large language model, input field types, output field types, and an output persona.

18. The method of claim 16, wherein transforming the baseline prompt into a structured prompt comprises utilizing one or more prompt engineering templates selected from a group consisting of: few-shot templates, chain of thought templates, tree of thought templates, and custom templates.

19. The method of claim 16, wherein generating the plurality of prompt variations comprises:
starting an iteration process by a prompt initializer based on the baseline prompt;
generating methodological instruction sets in batches based on records as cluster of elements from the reference dataset, wherein variation of elemental details are stored in the corresponding cluster set by using information from the reference dataset;
adapting the generated instruction sets from the cluster of elements to create generalized instruction sets; and
evaluating the generalized instruction sets using the performance metrics, which performs Bayesian optimization to get a prompt considering token and evaluation scores as trade off factor and reranking prompts to provide final instruction sets.

20. The method of claim 16, wherein the iterative prompt optimization process continues until the refined structured prompt achieves a predetermined performance threshold.

21. The method of claim 16, wherein the performance metrics comprise at least two metrics selected from a group consisting of: answer relevancy, answer correctness, answer faithfulness, answer similarity, answer exact match, and answer passage match.

22. The method of claim 16, wherein evaluating performance of the structured prompt comprises calculating a Mean Average of Metrics (MAM) score.

23. The method of claim 22, wherein the MAM score incorporates time coefficients and cost coefficients to determine optimal prompt variations.

24. The method of claim 16, wherein the computational optimization algorithms comprise Bayesian optimization and cluster mechanisms.

25. The method of claim 16, wherein performing the iterative prompt optimization process further comprises decomposing complex prompts into prompt sequences and optimizing the prompt sequences.

26. The method of claim 16, wherein transforming the baseline prompt into a structured prompt comprises:
automatically extracting information from document corpora; and
incorporating the extracted information into the structured prompt with prompt pipelines.
